(19) United States
(12) Patent Application Publication
(10) Pub. No.: US 2006/0085251 A1
(43) Pub. Date: Apr. 20, 2006

(54) System and method of presenting on-line product selection based on internal marketing and user popularity

(75) Inventor: Douglas F. Greene, Draper, UT (US)

Correspondence Address: BRACEWELL & GIULIANI LLP, P.O. BOX 61389, HOUSTON, TX, 77208-1389, US

(73) Assignee: Overstock.com, Inc.

(21) Appl. No.: 10/965,526

(22) Filed: Oct. 14, 2004

(51) Int. Cl. G07G 1/14

(52) U.S. Cl. 705/14

(57) ABSTRACT

An on-line Internet display of product viewing banners is selected and positioned in a predetermined viewing zone on a user screen, based upon: marketing personnel's selection/creation of a total selected number of possible preferred product viewing banners; and the number of hits on each preferred product viewing banner received from a user over a selected period of time; and where only a subset of the most popular preferred product viewing banners is displayed in the viewing zone based upon the total number of hits received over time for each of the preselected number of possible viewing banners.

### BACKGROUND OF THE INVENTION

1. Technical Field

The present invention relates in general to electronic commerce and, in particular, to systems, software, and methods for Internet commerce including an on-line Internet display of preferred product viewing banners selected and positioned in a predetermined viewing zone on a user screen, based upon marketing selection of banners, and the number of hits on each banner received from a user over a selected period of time; where only a subset of the most popular banners is displayed in the viewing zone based upon the total number of hits received over time for each of the banners.

2. Description of the Related Art

Commercial transactions conducted through electronic communication (e.g., via the World Wide Web (the Web)), commonly known as “e-commerce”, are a significant segment of the global economy. In a typical e-commerce transaction, a desktop or laptop computer user decides upon an item of goods or a service that the user is interested in purchasing. The user then initiates access to a retailer's or service provider's e-commerce website via the Web, perhaps after conducting a search for the website with a commercial search engine.

After the desired e-commerce website is located, the user searches the website for the desired item or service, either by conducting a search of the website or by paging through the website content. The user may then add the desired product or service to a virtual “shopping cart” that collects the user's intended purchases by selecting a graphical “button” associated with a graphical or textual description of the good or service. After the user indicates that all intended purchases have been added to the virtual “shopping cart,” the e-commerce website presents to the user a form into which the user enters and transmits payment information (e.g., credit card information). Once the payment information is approved, the website presents to the user a confirmation that the transaction is complete and may indicate a delivery schedule or methodology.

There have been many different attempts to improve the performance and public acceptance of e-commerce websites. For example, one type of website has an advertisement distribution management system that includes an advertisement insertion site linked to a commercial site via a management site device that distributes and manages the advertisements that are arranged on a network. Customers access the advertisement insertion site, which features advertisements distributed via the management site. The advertising site links to a commercial site via the advertisement insertion site, and visits the commercial site to perform actions for the customer. The commercial site sends the customer action information to the management site. The management site stores and manages the received customer action information, and refers to the customer action information to insert an advertisement whose contents are updated into the page of the advertisement insertion site when the same customer again accesses the advertisement insertion site. The advertisement distribution management system improves the hit rate of a banner advertisement by changing the contents of a banner advertisement according to customer action information.

Another type of website utilizes targeted advertising that is based upon demographics and user interaction. The website uses a graphical user interface that includes a display region used for banner advertising. The banner advertising display region is an information display region that displays advertisements of graphical images. The advertisements are replaced over time in response to data gathered about user demographic information and user interaction. Associated with each banner advertisement is data that determines when a particular banner is to be displayed.

Yet another prior art design tries to reach a target audience to increase the efficiency of Internet banner advertisements. This design allows an advertiser to present Internet banner advertisements to only those persons in a target audience, whose level of interest has reached the level of interest predetermined by the advertiser. In the system, the procedure defines an interest level for a target audience toward a specific Internet page or category based solely on the length of time the target audience has spent on it. The procedure only presents a group of advertisements in an Internet page category to the target audience if the target audience has spent a defined amount of time there. A group of advertisements in the same category is presented, at which point the system responds to whether the target audience reacts to the presented banner advertisements by clicking any of the presented banner advertisements.

Still other websites track client interaction and create client profiles, a resource database, and advertising banner evaluations. The network resource acquires client identifying indicia, such as the network ID, the client ID, the associated link (the URL of the web page), the amount of time the user spent interacting with the web page, and any selections made by the user while interacting with the web page. In this manner, the tracking program permits web site administrators and Internet advertisers to determine not only the number of user visits or hits made to a particular web page, but also permits an accurate determination of the length of time users have displayed or interacted with the web page. Internet advertisers use this information to make informed decisions as to the effectiveness and value of particular web pages and/or advertising banners.

Another website uses integrated advertising for wireless communication devices with rich content and direct user response. The system manages the display of advertisements and stores advertisements, including full screen and banner advertisements, and interprets and displays the content of an advertisement. The advertising manager selects advertisements and provides them for display. Advertisements may be selected from groups of related advertisements. Advertisements are selected on randomized but priority bases, allowing higher priority advertisements to be displayed more frequently than lower priority advertisements. Each advertisement identified in the display list has a priority. The priority of an advertisement file is determined by the service operator and the advertiser, and may be based on revenue that the service operator receives for placing the advertisement. An advertisement file appears in the display list with a frequency dependent on its priority relative to the priority of other advertisement files in the storage area.

In still another system, information is distributed through cooperative communication network sites. Information pertaining to products made by manufacturers and sold to consumers through retailers is distributed to consumers. A feature of this system makes use of a consumer “personal page,” which is an individualized database in which consumer shopping preferences are defined by: information that the consumer expressly provides; and the consumer's past shopping activity. Use of the personal page allows the consumer to receive product offers that are more targeted to the individual consumer, thus saving the consumer time and effort. Another feature provides for distribution of a product purchase incentive, directly by the user clicking on an advertising banner, wherein the product purchase incentive appears after the user clicks on the banner.

Other websites obtain consumer product preferences through product selection and evaluation. These systems obtain consumer preferences and search for products or services based on a consumer's search criteria. The products or services and/or advertisements are displayed related to the consumer's search criteria in accordance with the ranking parameters specified by the user. The search criteria and ranking parameters are used to determine consumer trends. After the search criteria and ranking parameters are processed, a series of rules determines which advertisements should be presented to the user. The system also arbitrates which advertisements should be presented to the user if the number of possible advertisements exceeds a preselected number.

Some systems monitor navigation of a user and present product information based on the navigation. These systems detect that the user is viewing content about a product and search databases having product information associated with the product, and product information associated with that product is selected based on the search. The selected product information is presented for output in a second window of a display being viewed by the user. User input relating to products is stored in a database. A request to send sales information associated with a product is received, and the database is searched for selecting users who have entered user input relating to the product associated with the sales information.

In another type of system, a reception system enables a user to display desired information, such as news, financial information, or cultural information. The computer network also enables a user to perform desired transactional services, such as banking and shopping. User inputs are received by the personal computer and processed by the network. User characteristics are monitored by the system in order to generate and display specific advertisements to the user based on individual usage characteristics and predetermined interests. Although each of these systems offers solutions for facilitating website interaction of on-line Internet users, and improved system of giving preferential treatment to product viewing banners based upon both user and provider criteria would be desirable.

### SUMMARY OF THE INVENTION

Briefly, the present invention provides a system, software, and methods of presenting on-line product selection for product purchasing or other types of electronic commerce. For example, in one embodiment, the type of product purchasing is from an on-line product retailer/wholesaler or catalog. In this embodiment, users access a product selection website and have a selection of “preferred product viewing banners” presented to them, with information about the product, such as an image or photograph, a brief description, and a price.

In operation, the present invention provides to users an on-line display of the “preferred product viewing banners” positioned in a preselected “viewing zone” on a user screen or interface. The preferred product viewing banners are selected based on two major criteria for the viewing zone: (1) marketing personnel's selection/creation of a total selected number of possible preferred product viewing banners; and (2) the number of hits on each preferred product viewing banner received from a user over a selected period of time. Thus, only a subset of the most popular preferred product viewing banners is displayed based on the number of previous hits. As any particular banner receives more hits, the banner moves into the preselected viewing zone. Essentially, in this embodiment of the present invention, the system, software, and methods operate to present a subset of preferred product viewing banners in a viewing zone based upon the total number of hits received over time from various users for each of the preselected number of possible viewing banners.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a high level block diagram of an illustrative e-commerce environment in which the present invention may be practiced;

FIG. 2 is a high level logical flowchart of one embodiment of a process illustrating interaction between a user and a website and is constructed in accordance with the present invention;

FIG. 3 is a schematic diagram of one embodiment of a system for presenting on-line product selection by electronic communication media from a product selection website, and is constructed in accordance with the present invention;

FIG. 4 is a block diagram of one embodiment of a database organization constructed in accordance with the present invention;

FIG. 5 is a schematic diagram of one embodiment of an exemplary display on a user terminal constructed in accordance with the present invention;

FIG. 6 is a block diagram of one embodiment of a computer-implemented method constructed in accordance with the present invention;

FIG. 7 is a high level block diagram of another embodiment of an e-commerce environment constructed in accordance with the present invention;

FIG. 8 is a block diagram of another embodiment of a database organization constructed in accordance with the present invention; and

FIG. 9 is a high level logical flowchart of another embodiment of a process illustrating interaction between a customer and a website and is constructed in accordance with the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

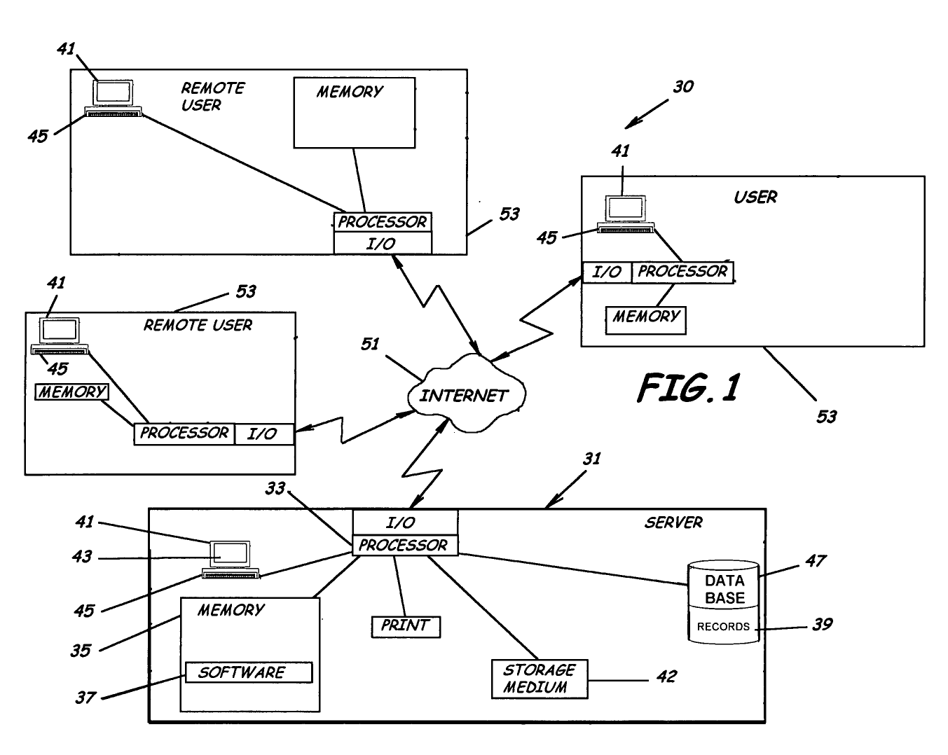

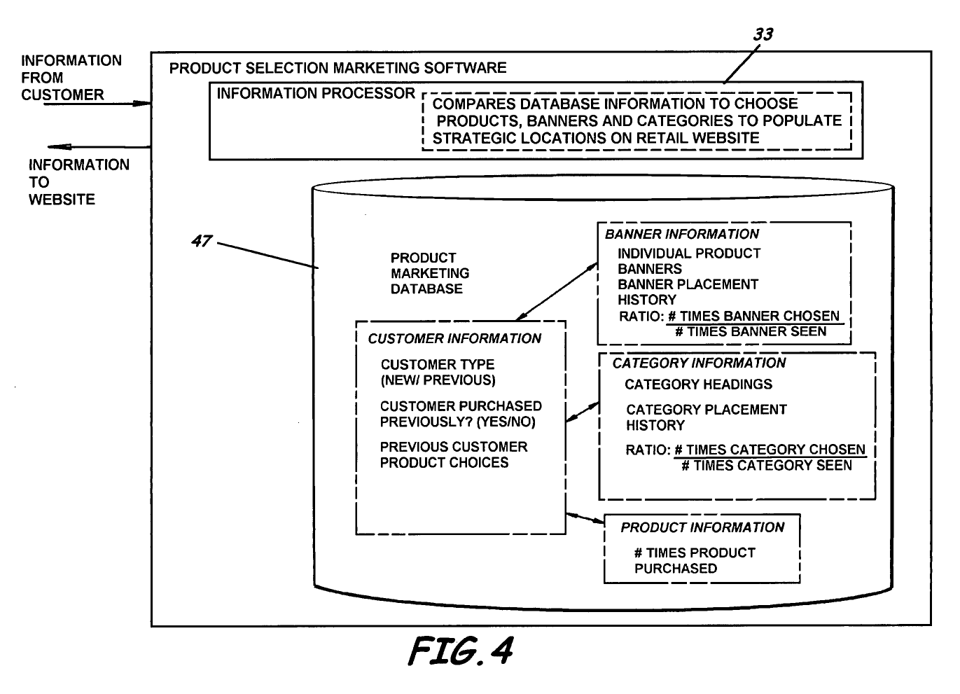

With reference now to the figures, and in particular with reference to FIGS. 1 and 4, there is illustrated one embodiment of an e-commerce environment in that is constructed in accordance with the present invention. Embodiments of the present invention advantageously provide a system and method of facilitating e-commerce on the Web. Embodiments of the present invention also include a computer readable medium containing a set of instructions or program causing the computer system to facilitate according to the present invention, and a database of product viewing banners and responses thereto formed by users of the computer system.

The present invention provides a computer-implemented method of presenting on-line product selection by electronic communication media from a product selection website for review by users. The steps of the computer-implemented method are implemented in a computer system 30 positioned at a site to define a server or server module 31. In one embodiment, the server 31 is actually a module having two separate types of machines, in order to provide processing/server capability for two functionalities. One of these functionalities is that of web/application processing, and the other is that of database processing. The web/application requirements functionality of the server 31 is furnished by a web/application server. Suitable units for this purpose are in the form of an appropriate number of, for example, Dell 1750 servers with dual CPUs, 1 GB RAM, and mirrored hard drives. The web/application servers are connected to a database server or server cluster which provides the database functionality. Database servers suitable for this purpose are, for example, Dell 2650 servers with dual CPU and 10 GB RAM. The database servers of server module 31 are attached to a high performance storage device, as will be described.

The set of instructions 37 also causes the processor to form and forward for retention and further use a set of database records 39. A graphical display 41 is coupled to the processor 33 for displaying graphical images as indicated at 43, and a user interface 45 coupled to the processor 33 to provide a user access to interact with and manipulate the software 37 and database records 39. An embodiment of the present invention also advantageously provides software for accomplishing these results that is stored on storage media 42.

It should be understood that the specific server identified above is given by way of example and that other types of servers or computers may be used. The server shown schematically at 31 represents a server or server cluster or server farm in the architecture and is not limited to any individual physical server. The server site may be deployed as a server farm or server cluster managed by a serving hosting provider. The number of servers and their architecture and configuration may be increased based on usage, demand and capacity requirements for the system 30.

The system 30 further includes in database 47 or a set or grouping of databases stored in the memory of the server 31 or in other suitable data storage media accessible to the server 31. The database 47 may also be provided in the form of a database server or server cluster. The particular database configuration is replicated based on capacity requirements for the system 30. The database 47 or databases further include at least a plurality of records 39 having data relating to the users and to the personal networks and business networks formed by users of the computer system. The system 30 further includes software 37 stored in memory 35 of the server 31 to process information within the system 30. The software 37 allows the server 31 to interface with users and generally allows the users to operate the computer system 30 according to the present invention for electronic commerce by promoting various product or service (hereinafter, “product”) viewing banners to users. In this manner, the system 30 may, according to the present invention, rate the popularity of banners based on user feedback, and thereafter allow subsequent users to consider only a most popular subset of the product viewing banners. The software instructions 37 allow a user to inquire about data or information from database 37 or the system 30.

The software or set of instructions 37 according to the present invention may be stored in a machine-readable storage medium, such as, but not limited to, any type of computer data storage disk including floppy disks, CD-ROMs, optical disks, magneto-optical disks, read-only memories (or ROMs), EPROMs, EEPROMs, random access memories (RAMs), magnetic or optical cards, or other types of media suitable for storage of a set of instructions that, when executed by the server 31, cause the server to perform the operations of the present invention.

The program set of instructions described in the present invention are not inherently related to or required by a particular computer or other server hardware. Various conventional computers or servers may be used according to the present invention. In addition, the present invention is not described with reference to any particular programming language. It will be understood that a variety of programming languages may be used to implement the system and method of the present invention as described herein.

In an embodiment of the present invention, the system 30 interfaces the area network or Internet 51 by communicating through the server 31, and a plurality of remote user computers 53 in communication with the Internet 51, located remote from the server 31 at a user site, and configured to access the server 31. The user computer 53 is typically a personal computer and may be connected over the Internet through a variety of configurations, such as through a stand-alone computer with individual access, or though a local area network (LAN) or wide area network (WAN). Access to the server 30 by the user computers may be made by a variety of communication links such optical cable, a wireless network such as a cellular network, satellite network or other access media.

When in communication with the server 31 through the Internet 51, the remote user computer 53 can access the software 37 for various purposes. The remote user computer 53 can retrieve records 39 from the server database 47 for display and user manipulation. The system 30 can also include still other devices 55, such as a portable computer, a PDA, a mobile telephone, and still other devices for accessing the Web, that are adapted to interface with the Internet 51 while positioned remote from the server 31.

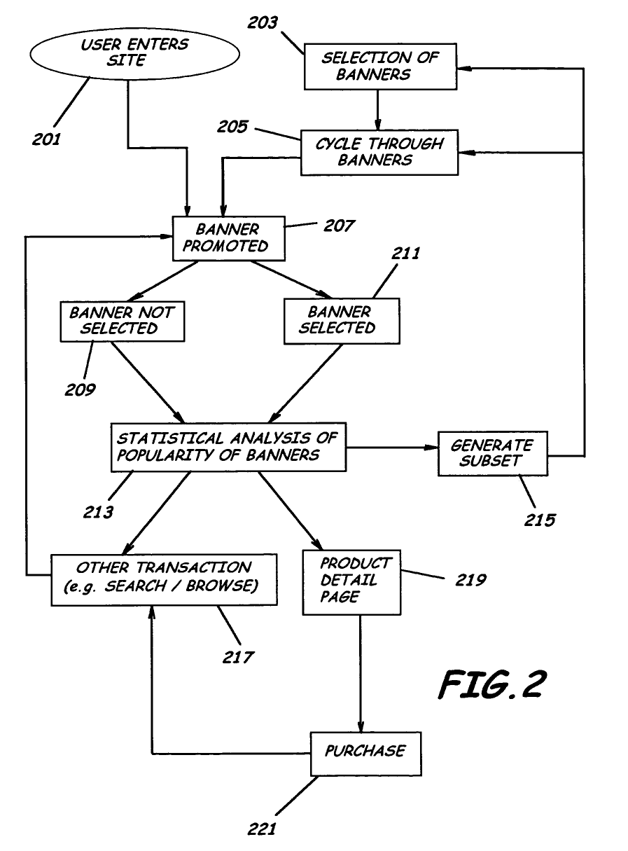

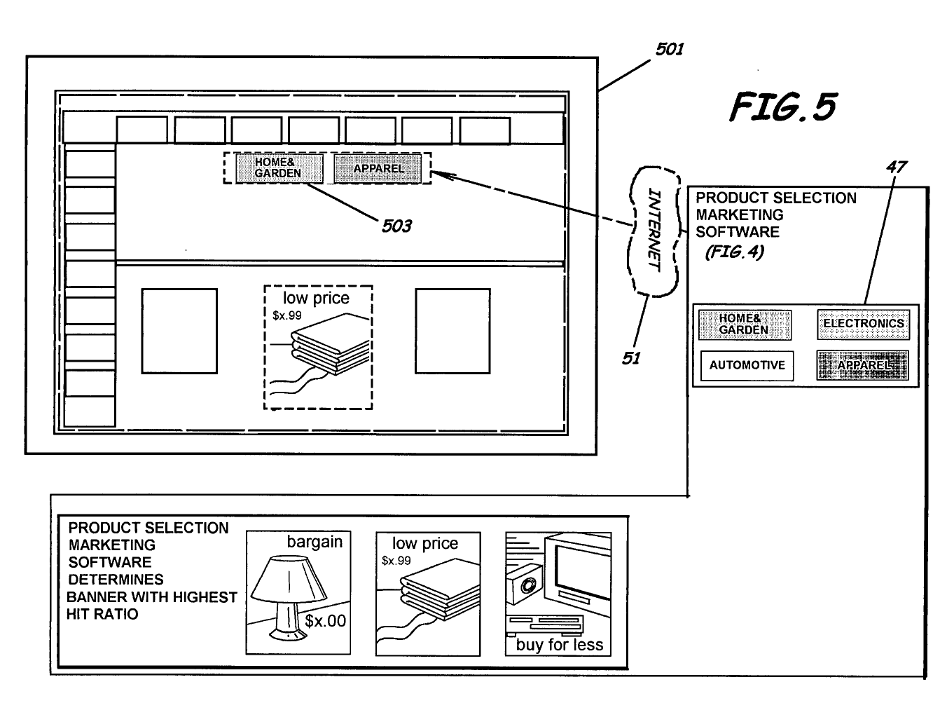

Referring now to FIGS. 2-6, an embodiment of a computer-implemented process according to the present invention begins as indicated at step 201 (FIG. 2) with a user entering from a user computer 53 an online product selection website such as that provided by server 31 of system 30. The on-line product selection website 31 presents a display image as indicated by an example from the product selection website 501 (e.g., FIG. 5) by electronic communication media for review by the user at the user's computer terminal 41. Requests for access to the product selection website for on-line product selection are responded to accordingly.

In addition to the product selection typically offered on the website, at least some of the display images (FIG. 5) available from the website include a “preferred” product viewing banner, as shown at 503, relating to one of the on-line products, as illustrated at step 207. The banner is “preferred” in the sense that the product associated with the banner has been selected (step 203) for greater and more prominent emphasis to users than other products. As shown at item 505, a product viewing banner may typically include, for example, an image of a product, a description of the product, and a price of the product, or a link (step 219) thereto for accessing such types of information.

The product viewing banner is pre-selected by operators or affiliates of the website server. In this sense, the operators are “internal” relative to an organization that operates and/or offers the website server and/or product selection website, whereas the users that access the website are “external” relative to the organization that is offering or operating the product selection website 31. For example, the selection of the preferred product viewing banner may be based on marketing directives that are internal relative to the organization that is offering or operating the product selection website 31. Typically, there are two or more product viewing banners that are being promoted to users.

In addition, a position of the product viewing banner transmitted to each user also may be prescribed. As shown in FIG. 5, for example, the position of the banners 503 is in a preselected viewing zone (e.g., “internally” preselected, relative to the organization) on the on-line display of the user, which is “external” relative to the organization.

The preferred product viewing banner is transmitted from the product selection website on request by a user for an on-line display. As shown at step 213, a record is formed of the user's response to the transmitted product viewing banner to indicate a popularity of the transmitted product viewing banner relative to other banners offered to users. The “popularity” of a banner may be determined in several ways, but is typically generated by users merely selecting (step 211) or not selecting (step 209) the banner, regardless of whether the product associated with banner is actually purchased. If a banner is selected by a user, information about the product (step 219) is presented to the user. The present invention also enables the user to purchase the product associated with the banner (step 221), or conduct other transactions (step 217).

The foregoing steps are repeated for other users. The plurality of product viewing banners are also cycled through (step 205) such that the product viewing banners are presented to other users. In one example, each product viewing banner is presented to numerous users. The product viewing banners may be selected and presented to users in many different ways. For example, the banners may be randomly selected, one at a time, from among the plurality of product viewing banners. In another example, the banners are sequentially selected from among the plurality of product viewing banners as additional users access the website.

In other embodiments, a user may be limited to viewing only one product viewing banner, or may be presented with numerous banners, e.g., one banner for each web page visited by the user. Other variables include the length of a user's visit to the website, where the program is in operation at the time of a user's visit, etc. However, generally a single user is exposed to numerous banners during a visit to the website.

As shown at step 213, a popularity ranking of the product viewing banners is formed and/or adjusted relative to other ones of the product viewing banners based on the formed records of user responses. The popularity ranking may be conducted for a desired period of time (e.g., one hour, one day, etc.), a desired sample size of user responses (e.g., 5000 user responses), etc. Based on the popularity ranking, a subset of the most popular product viewing banners is formed (step 215). Once the subset is formed, only those banners in the subset are presented to users (step 205) who visit the website subsequent to, for example, the conclusion of the initial sampling of user responses. The subset of the most popular product viewing banners typically comprises at least one product viewing banner. Alternatively, a popularity ranking of the most popular categories 507 (FIG. 5) of products may be monitored and utilized.

The popularity of the banners also may be determined dynamically on a real-time basis, such that the subset of the most popular product viewing banners is presented to users on a real-time basis. The present invention also contemplates contingencies such as, for example, removing a product viewing banner from availability for display to users when a product associated with the product viewing banner is sold out or otherwise unavailable.

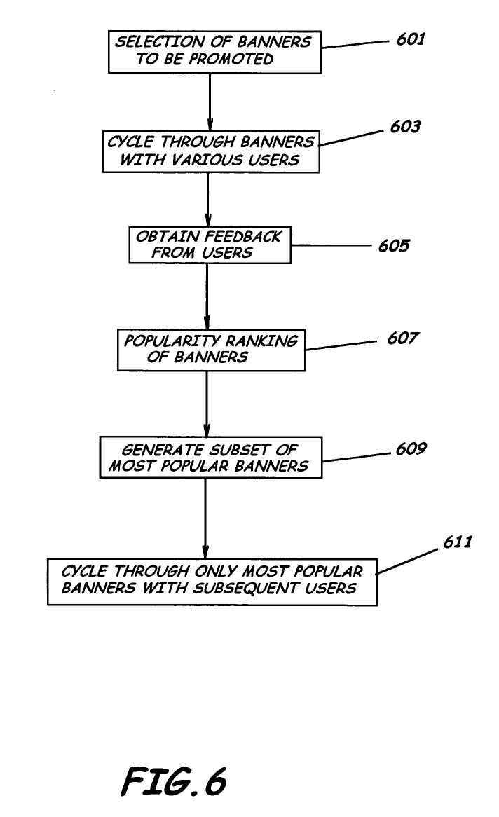

Referring now to FIG. 6, a block diagram of one embodiment of a computer-implemented method constructed in accordance with the present invention is shown. As shown at step 601, a selection is made of the banners to be promoted to users. The selected banners are then promoted to users, such as by a random cycle or sequential cycle, as illustrated at step 603. As depicted at step 605, feedback is obtained from users regarding each banner. A popularity ranking is then formed of the various selected banners, as shown at step 607. As illustrated at step 609, a subset of only the most popular banners is then generated. Finally, as depicted step 611, only the most popular banners (i.e., those in the subset) are presented to subsequent users.

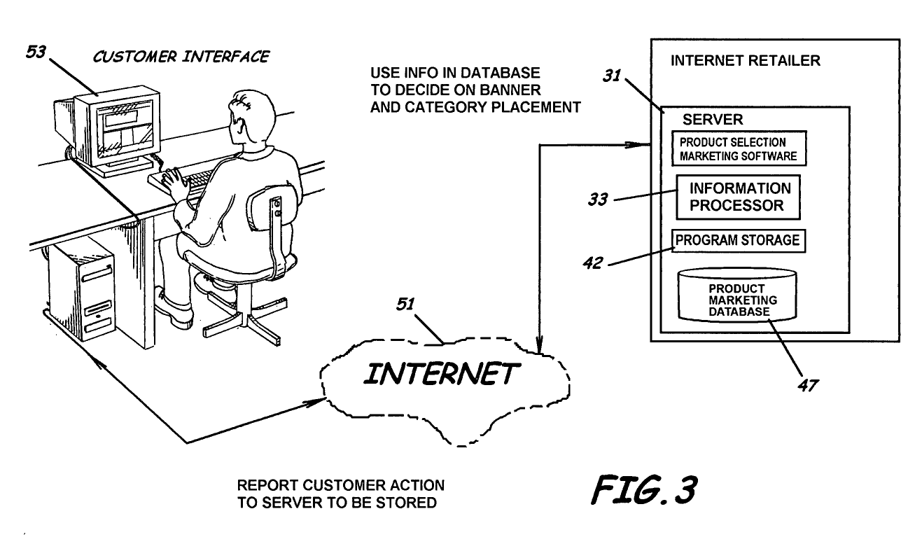

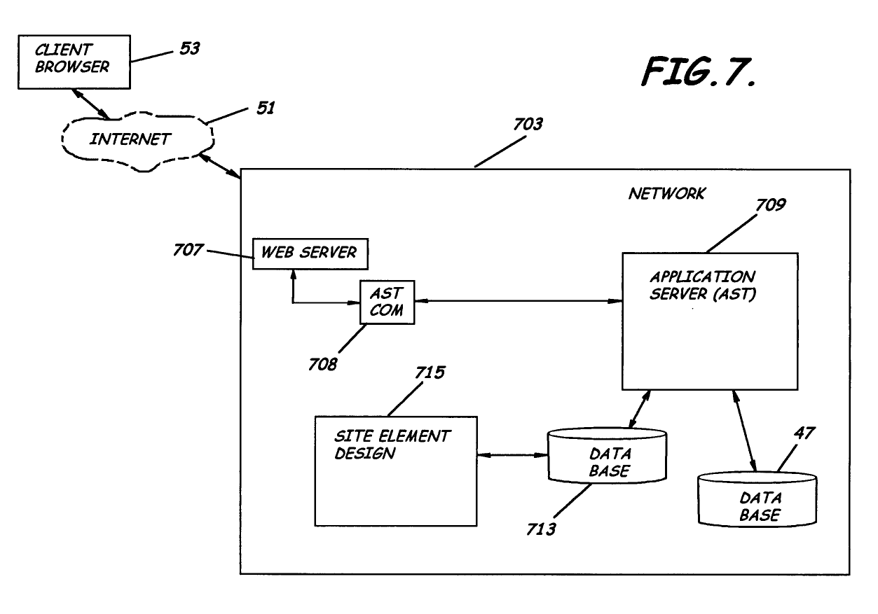

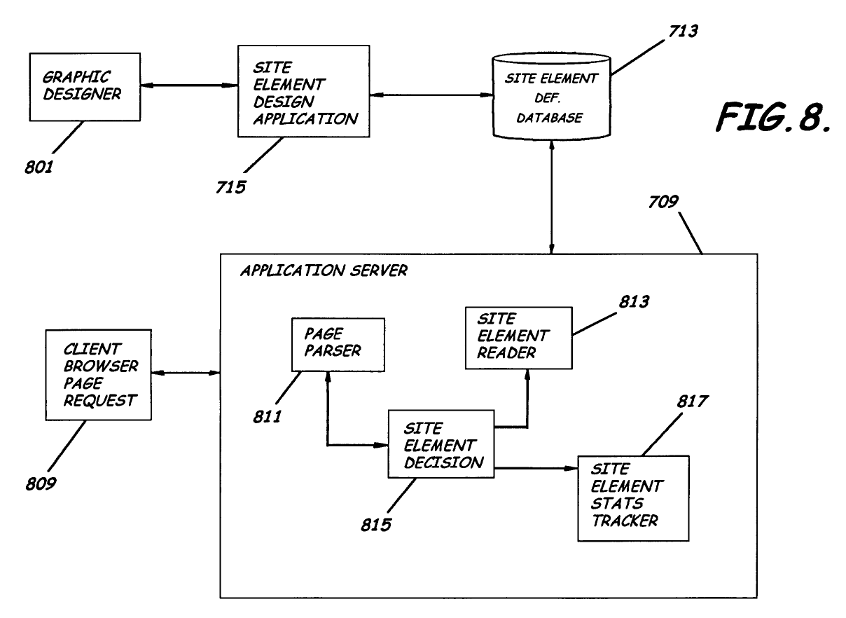

Referring now to FIGS. 7-9, another embodiment constructed in accordance with the present invention is shown. FIGS. 7 and 8 illustrate schematically the functionality provided with the present invention, while FIGS. 3-5 illustrate schematically examples of the data content and organization in accordance with the present invention. FIG. 7 depicts a high level block diagram illustrating client browser 53 of the type described above for communicating with a network 703 through the Internet 51. The network 703 comprises a web server 707 and an application server 709 that communicate via software 708 that facilitates transfer of data and communications such as that known as AST COM. It should be understood that other comparable software or hardware may be used for this purpose. The application server 709 has database 47, and communicates through another database 713 with one or more site element designs 715.

In operation (FIG. 8), a graphic designer (indicated schematically at 801) uses site element design application 715 to design a “creative” (e.g., product viewing banner) for each site element through database 713. Examples of creatives or product viewing banners are illustrated in FIG. 5. An unlimited number of creatives can be created for each site element, and within site elements for each marketing segment, subject only to memory capacity of the database 713. The database 713 transmits information to application server 709, which interacts with customers through client browser page requests 809. At the application server 709, site element decisions 815, as indicated in response to client browser page requests 809 regarding the contents of database 713, are made to parse pages (as indicated at 811) and render pages functionality (as indicated at 813). A “track statistics” functionality 817 is provided to form, update and retain in storage of the creatives or product viewing banners in database 713 based on the content and nature of the browser page requests as they are made.

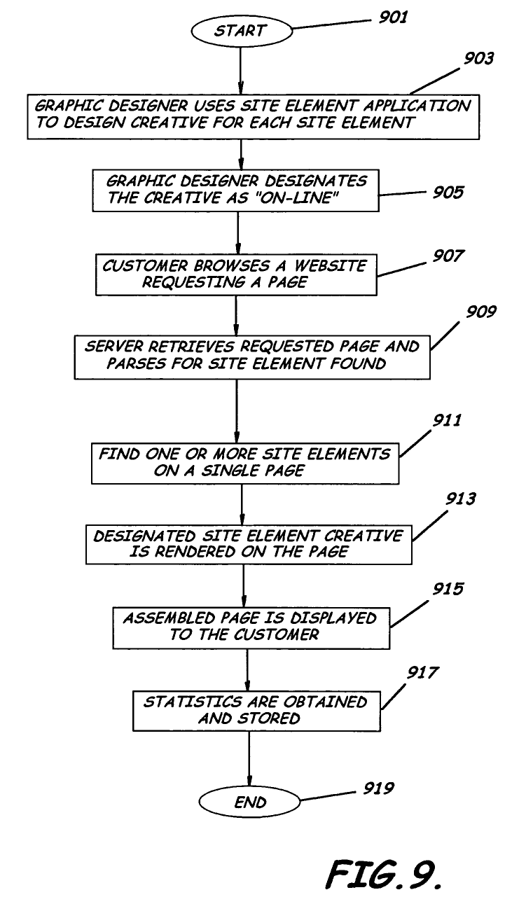

As shown in FIG. 9, one embodiment of a method of this embodiment of the present invention starts as indicated at step 901, and a creative of the type illustrated in FIG. 5 and discussed above is designed, as illustrated at step 903. Once a creative is complete for a site element, the graphic designer designates the creative as “on-line”, as depicted at step 905. As illustrated at step 907, a customer browses a website and requests a page of one or more creative banners. The application server 709 (FIG. 7) retrieves the requested page from database 713 and parses it as indicated at 811 for site elements, as depicted at step 909. As illustrated at step 911, one or more site elements are found on a single page. For each site element found, the communication and data interchange with the customer is designated (step 913) as a “sample session” or a “normal session.” The next available creative for the site element is displayed (step 915) in sample sessions in, for example, a round-robin fashion. In normal sessions, the top creative is displayed (step 915) for the site element based on the purchasing behavior in the sample sessions stored in the manner described above. In either case, the designated site element creative from database 713 is rendered on the page, and the assembled page is transmitted back over the Internet 51 to the customer browser 701. Statistics are obtained and stored (step 917) in the database 713 regarding the number of sessions displayed and purchases related to the site element, before ending at step 919.

While the invention has been shown or described in only some of its forms, it should be apparent to those skilled in the art that it is not so limited, but is susceptible to various changes without departing from the scope of the invention.

What is claimed is:

1. A computer implemented method of presenting on-line product selection by electronic communication media from a product selection website for review by users, comprising the steps of:
(a) transmitting a product viewing banner relating to an on-line product from the product selection website on request by a user for an on-line display;
(b) forming a record of the user's response to the transmitted product viewing banner to indicate a popularity of the transmitted product viewing banner;
(c) repeating steps (a) and (b) for other users, and cycling through a plurality of product viewing banners, such that the product viewing banners are presented to other users;
(d) forming a popularity ranking of the product viewing banners relative to other ones of the product viewing banners based on the formed records of user responses; and then
(e) presenting a subset of the most popular product viewing banners to users based on the popularity ranking formed based on user responses.

2. The method of claim 1, further including the step of presenting a group of product viewing banners from the website server.

3. The method of claim 1, further including the step of:
responding to requests for access to the product selection website for on-line product selection.

4. The method of claim 1, further including the step of:
positioning the transmitted product viewing banner in a preselected viewing zone on the on-line display of the user.

5. The method of claim 1, wherein the subset of the most popular product viewing banners comprises at least one product viewing banner.

6. The method of claim 1, wherein step (a) is based on marketing directives that are internal relative to an organization operating or offering the product selection website.

7. The method of claim 1, wherein step (b) is based on responses from users that are external relative to an organization operating or offering the product selection website.

8. The method of claim 1, wherein step (a) is based on marketing directives that are internal relative to an organization operating or offering the product selection website, step (b) is based on responses from users that are external relative to the organization; and further including the step of:
positioning the transmitted product viewing banner in an internally preselected viewing zone on the on-line display of the external user.

9. The method of claim 1, wherein the cycling step of step (c) comprises randomly selecting one of the product viewing banners from among the plurality of product viewing banners.

10. The method of claim 1, wherein the cycling step of step (c) comprises sequentially selecting one of the product viewing banners from among the plurality of product viewing banners.

11. The method of claim 1, wherein step (b) comprises presenting information about a product in response to the product viewing banner being selected.

12. The method of claim 1, wherein step (b) comprises enabling a purchase of a service/product associated with the product viewing banner.

13. The method of claim 1, wherein step (d) comprises determining popularity over a selected period of time, and step (e) comprises presenting the subset of the most popular product viewing banners after said selected period of time.

14. The method of claim 1, wherein step (d) comprises determining popularity on a real-time basis and step (e) comprises presenting the subset of the most popular product viewing banners on a real-time basis.

15. The method of claim 1, further comprising removing a product viewing banner from availability for display to users when a service/product associated with the product viewing banner is unavailable.

16. The method of claim 1, wherein the product viewing banner includes an image of a product.

17. The method of claim 1, wherein the product viewing banner includes a description of a product.

18. The method of claim 1, wherein the product viewing banner includes a price of a service/product.

19. A computer server presenting information as a product selection website for on-line product selection by users over a publicly accessible computer network, comprising:
a processor;
an interface connecting the processor to the publicly accessible computer network for communication with users;
a storage medium containing information about on-line products for selection by users;
said processor transmitting from the storage medium a product viewing banner relating to an on-line product from the product selection website on request by a user for an on-line display on the computer and forming in the storage medium a record of the user's response to the transmitted product viewing banner through the computer to indicate a popularity of the transmitted product viewing banner;
the processor further repeatedly transmitting product viewing banners and forming records of user responses and cycling through a plurality of product viewing banners stored on the storage medium, such that the product viewing banners are presented to other users through the computer;
the processor further forming in the storage medium a popularity ranking of the product viewing banners relative to other ones of the product viewing banners based on the formed records of user responses; and
the processor further presenting a subset of the most popular product viewing banners to users over the publicly accessible computer network based on the popularity ranking formed from the user responses.

20. The computer server of claim 19, further including the processor presenting a group of product viewing banners from the storage medium.

21. The computer server of claim 19, further including the processor responding to requests for access to the product selection website for on-line product selection over the publicly accessible computer network.

22. The computer server of claim 19, further including the processor positioning the transmitted product viewing banner in a preselected viewing zone on the on-line display of the user.

23. The computer server of claim 19, wherein the subset of the most popular product viewing banners presented by the processor comprises at least one product viewing banner from the storage medium.

24. The computer server of claim 19, wherein the product viewing banner presented by the processor is based on marketing directives that are internal relative to an organization operating or offering the product selection website.

25. The computer server of claim 19, wherein the record formed in the storage medium is based on responses from users that are external relative to an organization operating or offering the product selection website.

26. The computer server of claim 19, wherein the product viewing banner presented by the processor is based on marketing directives that are internal relative to an organization operating or offering the product selection website, the record formed in the storage medium is based on responses from users that are external relative to the organization; and further including the processor positioning the transmitted product viewing banner in an internally preselected viewing zone on the on-line display of the external user.

27. The computer server of claim 19, further including the processor randomly selecting one of the product viewing banners from among the plurality of product viewing banners on the storage medium.

28. The computer server of claim 19, further including the processor sequentially selecting one of the product viewing banners from among the plurality of product viewing banners on the storage medium.

29. The computer server of claim 19, further including the processor presenting information about a product from the storage medium in response to the product viewing banner being selected on the computer.

30. The computer server of claim 19, further including the processor enabling a purchase of a product associated with the product viewing banner over the publicly accessible computer network.

31. The computer server of claim 19, further including the processor determining popularity over a selected period of time, and presenting the subset of the most popular product viewing banners from the storage medium after said selected period of time over the publicly accessible computer network.

32. The computer server of claim 19, further including the processor determining popularity on a real-time basis and presenting the subset of the most popular product viewing banners from the storage medium on a real-time basis over the publicly accessible computer network.

33. The computer server of claim 19, further comprising the processor removing a product viewing banner from availability for display to users when a product associated with the product viewing banner is unavailable.

34. A system to present on-line product selection over a publicly accessible computer network, comprising:
a server computer at a site accessible to the computer network, the server computer having a processor, memory coupled to the processor to store operating instructions therein, and a graphical display coupled to the processor for displaying graphical images;
a database accessible to the processor of the server computer and containing database records about product selection;
the machine-readable instructions stored in the memory of the server computer to causing the processor to perform the following operations: transmit from the server computer a product viewing banner relating to an on-line product from a product selection website on request by a user for an on-line display; form at the server computer a record of the user's response to the transmitted product viewing banner to indicate a popularity of the transmitted product viewing banner; and cycle through a plurality of product viewing banners, such that the product viewing banners are presented to other users; form at the server computer a popularity ranking of the product viewing banners relative to other ones of the product viewing banners based on the formed records of user responses; and present from the server computer a subset of the most popular product viewing banners to users;
a user interface coupled to the processor to provide user access over the computer network for access to the database records;
a user computer at a user site accessible to the computer network, the user computer having a processor, memory coupled to the processor to store software therein, and to receive database records therein, a graphic display coupled to the processor for displaying graphic images, and a user interface coupled to the processor to provide a user access to manipulate the stored software and received database records;
the user computer being interconnected to the server computer over the publicly accessible computer network to view a transmitted product viewing banner relating to an on-line product from the product selection website;
the database accessible to the processor of the server computer storing a record of the user's response to the transmitted product viewing banner to indicate a popularity of the transmitted product viewing banner; and
the server computer cycling through a plurality of product viewing banners to present the product viewing banners to other users, such that a popularity ranking of the product viewing banners is formed from the user responses in order to present a subset of the most popular product viewing banners to users.

35. The system of claim 34, wherein the product viewing banners are selected based on marketing directives that are internal relative to an organization responsible for the product selection website, and popularity of the product viewing banners is based on responses from users that are external relative to the organization.

36. The system of claim 35, wherein the transmitted product viewing banner is positioned in an internally preselected viewing zone on the graphic display of the user external to the organization.

37. The system of claim 34, wherein popularity of the product viewing banners is determined over a selected period of time, and the subset of the most popular product viewing banners is presented to users after said selected period of time.

38. The system of claim 34, wherein popularity is determined on a real-time basis and the subset of the most popular product viewing banners is presented to users on a real-time basis.

39. A computer readable medium that is readable by a computer connected to a publicly accessible computer network to facilitate electronic commerce over the computer network with users, the computer readable medium comprising:
a set of instructions that, when executed by the computer, cause the computer to perform the following operations: transmit from the computer a product viewing banner relating to an on-line product from the product selection website on request by a user for an on-line display; form at the computer a record of the user's response to the transmitted product viewing banner to indicate a popularity of the transmitted product viewing banner; cycle through a plurality of product viewing banners, such that the product viewing banners are presented to other users; form at the computer a popularity ranking of the product viewing banners relative to other ones of the product viewing banners based on the formed records of user responses; and present from the computer a subset of the most popular product viewing banners to users.

40. A computer memory element containing stored in signal bearing media a database, the database containing the following data in computer readable format:
data indicating a plurality of product viewing banners relating to on-line products from a product selection website for transmission to users on a publicly accessible computer network;
data indicating records of the users' responses to the transmitted product viewing banners to indicate a relative popularity of the transmitted product viewing banners; and
data indicating a popularity ranking of the product viewing banners relative to other ones of the product viewing banners based on the formed records of user responses.

41. The database of claim 40, further including data indicating a subset of the most popular product viewing banners presented to users.

42. A computer system facilitating electronic commerce over a publicly accessible computer network, comprising:
a processor;
a storage medium having data accessible to the processor;
an input/output for transferring data to the processor;
the processor comprising:
means for transmitting a product viewing banner relating to an on-line product from a product selection website on request by a user for an on-line display;
means for forming a record of the user's response to the transmitted product viewing banner to indicate a popularity of the transmitted product viewing banner;
means for cycling through a plurality of product viewing banners, such that the product viewing banners are presented to other users;
means for forming a popularity ranking of the product viewing banners relative to other ones of the product viewing banners based on the formed records of user responses; and
means for presenting a subset of the most popular product viewing banners to users.

43. A method of presenting on-line product selection for purchase by a user, comprising:
(a) preparing a group of product viewing banners for a product selection website;
(b) accessing the product selection website by a user;
(c) presenting one of the product viewing banners to the user in an on-line display of the product selection website;
(d) positioning said one of the product viewing banners in a preselected viewing zone on an interface of the user;
(e) tracking the user's response to said one of the product viewing banners, such that a popularity of said one of the product viewing banners is increased if the user selects said one of the product viewing banners;
(f) repeating steps (b) through (e) for other users, and cycling through the product viewing banners in the group repetitively, such that the product viewing banners are presented to multiple users;
(g) ranking the product viewing banners relative to each other based on popularity; and then
(h) presenting one of a subset of the most popular product viewing banners to subsequent users based on step (g).

44. The method of claim 43, wherein step (a) is based on marketing directives that are internal relative to an organization operating or offering the product selection website, step (b) is based on users that are external relative to the organization, and step (d) comprises internally preselecting the viewing zone and the interface of the user is external.

45. The method of claim 43, wherein step (g) comprises determining popularity over a selected period of time, and step (h) comprises presenting the subset of the most popular product viewing banners after said selected period of time.

46. The method of claim 43, wherein step (g) comprises determining popularity on a real-time basis and step (h) comprises presenting the subset of the most popular product viewing banners on a real-time basis.
